(19) United States
(12) Patent Application Publication
(10) Pub. No.: US 2005/0138635 A1
(43) Pub. Date: Jun. 23, 2005

(54) Updating a deferred copy of a data message

(75) Inventors: Joshua S. Auerbach, Ridgefield, CT (US); Timothy J. Baldwin, Swanmore (GB); Susan P. Paice, Eastleigh (GB)

Correspondence Address: Jerry W. Herndon;IBM Corp, IP Law Dept T81/503, 3039 Cornwallis Road, PO Box 12195, Research Triangle Park, NC, 27709-2195, US

(73) Assignee: International Business Machines Corporation, Armonk, NY (US)

(21) Appl. No.: 10/925,060

(22) Filed: Aug. 24, 2004

(30) Foreign Application Priority Data
Dec. 17, 2003 (GB) 0329200.0

(51) Int. Cl. G06F 12/00

(52) U.S. Cl. 719/315

(57) ABSTRACT

A method for generating a copy of a first message in a messaging system, wherein the first message includes a nested data item comprising data items, the method comprising the steps of: creating a second message as a deferred copy of the first message; responsive to a determination that one of said data items addressed at the second message location is to be updated, creating an actual copy of the updated data item in the second message.

### FIELD OF THE INVENTION

This invention relates to updating data items in a deferred copy of a data message. In particular, the invention relates to creating actual copies of data items that are updated.

### BACKGROUND OF THE INVENTION

Computer data messaging systems include message producers and message consumers for the distribution of application or business data. Message producers and message consumers are typically individual computer systems configured to communicate with each other, such as over a network. Message producers generate data messages that can include a number of data items, such as a header containing administrative information and a payload containing the information that the message is intended to deliver. For example, payload data can include data specific to a particular business application. The data messages are sent to message consumers who use the data message, such as business processes.

When a consumer receives a data message, it may make an update to the contents of all or part of the message. For example, a consumer may add information to a message, such as a time-stamp, or update an existing time stored in the message. Such updates to a data message made by a consumer should not be visible to the producer of the message, or other consumers who will also receive the message. This is because an update to the data message made by a particular consumer is specific to that consumer. To overcome the problem of consumers receiving a data message that has been updated by other consumers, each consumer can take a copy of the message. A copy of the message can be updated by a consumer who made the copy without affecting the original message that is visible to all other consumers. While a consumer taking a copy of a message overcomes the problem of updates to the message being visible to other consumers, such copies are unnecessary if a consumer does not update a data message. Consequently, redundant copies of a data message can exist on consumer computer systems. A redundant copy of a data message represents a waste of resources; processing time is wasted generating the redundant copy and storage space is wasted recording the redundant copy. Furthermore, a data message containing a large amount of data will be copied in its entirety even when a consumer may only update a small fraction of the complete message data. For example, a data message containing a small header and a voluminous payload may be copied in its entirety even if a consumer will only change a time-stamp in the message header. Thus, the copy of the voluminous payload is extraneous where only the small header is updated.

One known technique to alleviate some of these problems is to take a ‘deferred’ or ‘lazy’ copy of a data message as opposed to a complete copy of the message. To generate a lazy copy of an original data message a place-holder is used to represent a copy of the original message, but instead of including a complete copy of all data items in the original message the place-holder simply refers to the original message. Thus, the place-holder is actually a reference to the original message, and data items can be addressed within the place-holder, although no actual copy of the data items exists within the place-holder. Subsequently, if a data item addressed within the place-holder is updated, a full copy of all data items from the original data message are generated by populating the place-holder with a complete copy of all data items in the original data message. The required update can then be made to the data item in the copy of the message. In this way the complete message data is not actually copied until an update is made to the copy of the message, so avoiding unnecessary redundant copies of the original data message. However, the technique of lazy copying does not overcome the problem of duplicating all data in an original message when only a small fraction of the original message is updated. For example, if an original data message contains a small header and a voluminous payload, a lazy copy can be generated by a message consumer as a place-holder with a reference to the original data message. Subsequently, if the consumer updates a time-stamp addressed within the place-holder, a complete copy of the original message is generated within the place-holder. Thus, using a lazy copy technique, even when a small change is required a complete copy of all message data takes place.

It would therefore be desirable to provide a way for a message consumer to make updates to data messages in a messaging system without the updates being visible to other consumers in the messaging system, and without generating redundant copies of unnecessary message data, such as message data that is not updated.

### SUMMARY OF THE INVENTION

The present invention accordingly provides, in a first aspect, a method for generating a copy of a first message including nested data items in a messaging system. The method has the steps of: creating a second message as a lazy copy of the first message; responsive to a determination that one of said data items addressed at the second message location is to be updated, creating an actual copy of the updated data item in the second message.

A message consumer initially creates a lazy copy of a data message. Subsequently, if the consumer updates a data item addressed in the lazy copy of the data message, an actual copy of the data item to be updated is generated. Other data items in the lazy copy of the data message continue to be lazy copies. In this way, only data items that are updated are copied as actual copies, with all other data items being copied as lazy copies. Thus the method avoids unnecessarily generating redundant actual copies of data items or whole data messages that will not be updated. The method also avoids the storage of redundant copies of data items or data messages.

Preferably an actual copy of a parent data item of the updated data item is also created.

Preferably a lazy copy of a child data item of the parent data item is also created.

The present invention accordingly provides, in a second aspect, an apparatus for generating a copy of a first message in a messaging system. The first message includes nested data items, and the apparatus comprises: means for creating a second message as a lazy copy of the first message; means responsive to a determination that one of said data items addressed at the second message location is to be updated for creating an actual copy of the data item in the second message.

The present invention accordingly provides, in a third aspect, a computer program product comprising computer program code stored on a computer readable storage medium that, when executed on a data processing system, instructs the data processing system to carry out the method described above.

### BRIEF DESCRIPTION OF THE DRAWINGS

A preferred embodiment of the present invention will now be described, by way of example only, with reference to the accompanying drawings, in which:

FIG. 1a is a block diagram of a lazy copy of a data message in the prior art;

FIG. 1b is a block diagram of an actual copy of a data message in the prior art;

FIG. 2a is a block diagram of a lazy copy of a data message in accordance with a preferred embodiment of the present invention;

FIG. 2b is a flowchart illustrating a method for generating a copy of a data message in accordance with a preferred embodiment of the present invention;

FIG. 3 is a flow chart illustrating an exemplary method to update a nested data item addressed in a lazy copy of a data message in accordance with a preferred embodiment of the present invention;

FIG. 4a is a block diagram of a lazy copy of a data message in accordance with a preferred embodiment of the present invention; and

FIG. 4b is a block diagram of a lazy copy of the data message of FIG. 4a in which the “A22” data item is updated in accordance with a preferred embodiment of the present invention.

### DETAILED DESCRIPTION OF THE PREFERRED EMBODIMENT

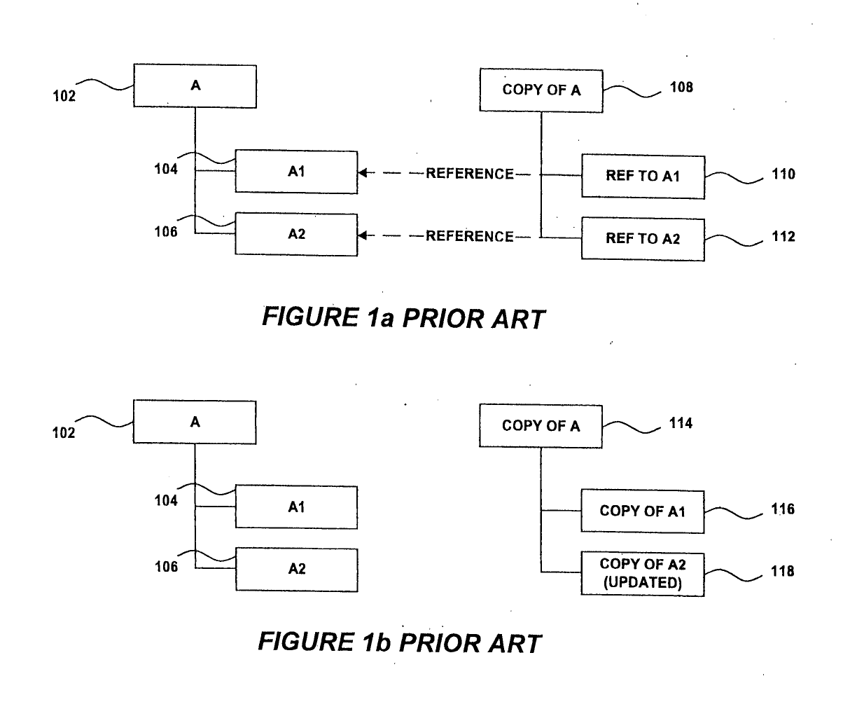

FIG. 1a is a block diagram of a lazy copy of a data message in the prior art. A data message “A” 102 comprises two data items, “A1” 104 and “A2” 106. The data message “A” 102 is a data message generated by a producer computer system and transmitted on a computer network to consumer computer systems. Alternatively, the data message “A” 102 can be any data message in a messaging system. Data items “A1” 104 and “A2” 106 are elements within the data message “A” 102. For example, data items “A1” 104 can be a header data item and “A2” 106 can be a payload data item. A header data item can include information regarding the structure and content of the entire data message “A” 102 such as length information, chronological information (e.g. when the message “A” 102 was generated) or encryption information. A payload data item can include application data relevant to a software application executing on one or more consumer computer systems. For example, a payload data item can include business application data. Alternatively, data items “A1” 104 and “A2” 106 can be single data values such as single data variables.

A consumer in the messaging system receives the data message “A” 102 and generates a lazy copy of the data message “COPY OF A” 108. “COPY OF A” 108 is a place-holder representing a copy of data message “A” 102. “COPY OF A” 108 is not an actual copy of data message “A” 102. Rather, “COPY OF A” 108 includes references to the data items of data message “A” 102 including “REFERENCE TO A1” 110 and a “REFERENCE TO A2” 112. A reference to a data item can be a memory pointer to the data item in a memory of a computer system. Alternatively, a reference to a data item can be an object reference in an object oriented system, or a location of the data item on a non-volatile storage device of the computer system. Thus, “COPY OF A” 108 provides a consumer of the messaging system with a copy of the message “A” 102 while not requiring actual copies of the data items “A1” 104 and “A2” 106 to be generated, as references are provided to “A1” 104 and “A2” 106.

When the consumer updates one of the data items in “COPY OF A” 108 by addressing “REFERENCE TO A1” 110 or “REFERENCE TO A2” 112, the “COPY OF A” 108 is converted into an actual copy of the data message “A” 102 including actual copies of the data items “A1” 104 and “A2” 106. For example, if the consumer updates a value referenced by “REFERENCE TO A2” 112, the data items “REFERENCE TO A1” 110 and “REFERENCE TO A2” 112 that are references to data items “A1” 104 and “A2” 106 of data message “A” 102 will be replaced with actual copies of data items “A1” 104 and “A2” 106. This replacement with actual copies is required so that the lazy copy “COPY OF A” 108 can be updated without affecting the data message “A” 102. Such an actual copy is illustrated in FIG. 1b. Referring to FIG. 1b, the data message “A” 102 and data items “A1” 104 and “A2” 106 are identical to those described with respect to FIG. 1a and these will not be further described here in the description of FIG. 1b. FIG. 1b further includes a “COPY OF A” 114 that is an actual copy of data message “A” 102 in contrast to the lazy copy of FIG. 1. The “COPY OF A” 114 contains a clone of each of the data items of data message “A” 102. Thus, the “COPY OF A” 114 includes data item “A1” 116 that is a copy of data item “A1” 104. The “COPY OF A” 114 also includes data item “A2” 118 that is an update of data item “A2” 106. It is this update that caused the lazy copy of FIG. 1a to be converted to the actual copy of FIG. 1b in this example.

Thus the prior art techniques of FIGS. 1a and 1b require that a lazy copy of a data message is converted to an actual copy of the data message when any data items addressed within the lazy copy are updated. This has the disadvantage that all data items in the data message are copied even when only a single data item is updated.

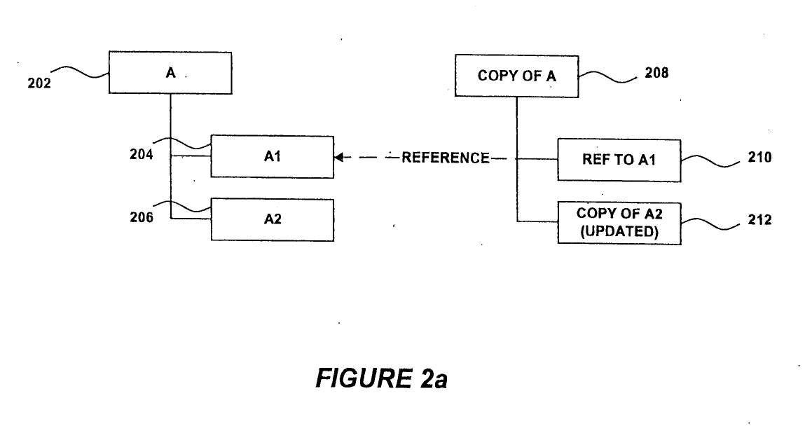

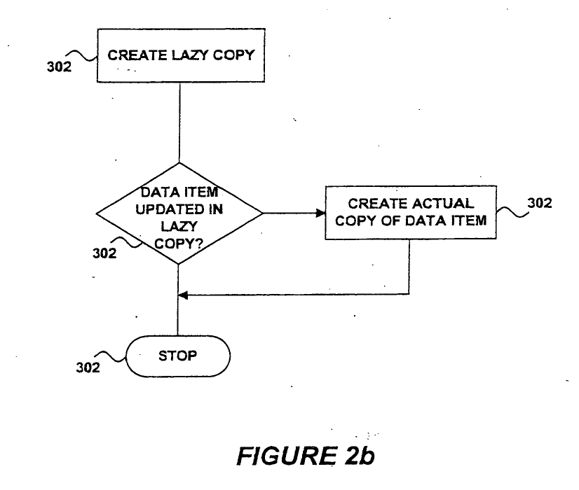

FIG. 2a is a block diagram of a lazy copy of a data message in accordance with a preferred embodiment of the present invention. The data message “A” 202 and data items “A1” 204 and “A2” 206 are identical to those described with respect to FIG. 1a and these will not be further described here in the description of FIG. 2a. When a consumer generates a copy of the data message “An 202, a lazy copy of the data message is generated. The lazy copy will be identical to the lazy copy of FIG. 1a. Subsequently, when the consumer updates one of the data items in the lazy copy of the data message “A” 202, the lazy copy is changed to that illustrated as “COPY OF A” 208 in FIG. 2a. The “COPY OF A” 208 is a lazy copy of the data message “A” 202 containing “REFERENCE TO A1” 210 that is a reference to data item “A1” 204. The “COPY OF A” 208 also contains “COPY OF A2” 212 that is an actual copy of data item “A2” 206. Thus, the “COPY OF A” 208 is a partial lazy copy of data message “A” 202 in which an update has been applied to a data item referencing “A2” 206. To accommodate this update, a copy of the “A2” 206 data item is generated in the “COPY OF A” 208 as “COPY OF A2” 212.

In contrast to the prior art technique of performing an actual copy of all data items of data message “A” 202, the lazy copy of data message “A” 208 only includes an actual copy of the updated data item “A2” 212. Data item “A1” 210, which is not updated in the lazy copy of data message “A” 208, continues to be a reference to the data item “A1” 204 of data message “A” 202. In this way, the lazy copy of data message “A” 208 of FIG. 2a does not include redundant data items that are not updated, and a consumer using the lazy copy of data message “A” 208 does not need to spend time unnecessarily performing a copy of redundant data items. Also, there is no need to use local storage unnecessarily to store such redundant data items.

The technique described above with respect to FIG. 2a for generating a copy of an original data message in a preferred embodiment of the present invention is formalised in FIG. 2b. Starting at step 250 of FIG. 2b, a lazy copy of the original data message is generated. The lazy copy can be generated using known prior art techniques as described hereinbefore with respect to FIG. 1a and as well known in the art. Subsequently, at step 252, an update to a data item in the lazy copy of the original message is detected and at step 254 an actual copy of the updated data item is generated. In this way, actual copies of data items in the original data message are only copied as they are updated. Thus, data items that are not updated need not be copied so preventing redundant copies of data items that are not updated.

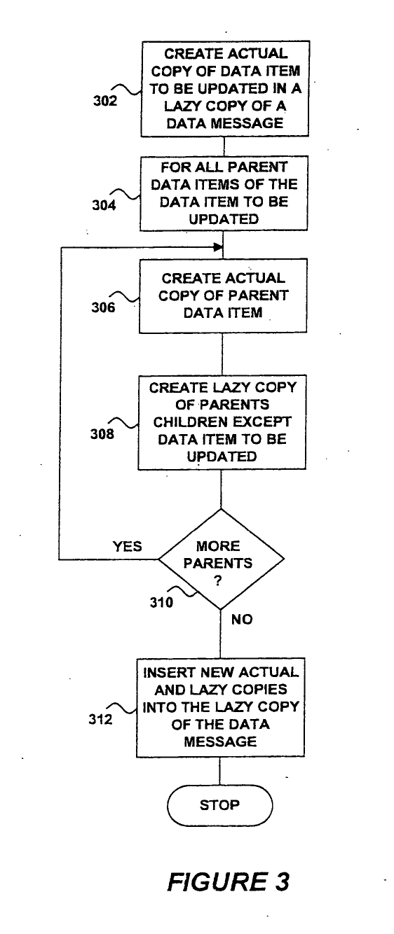

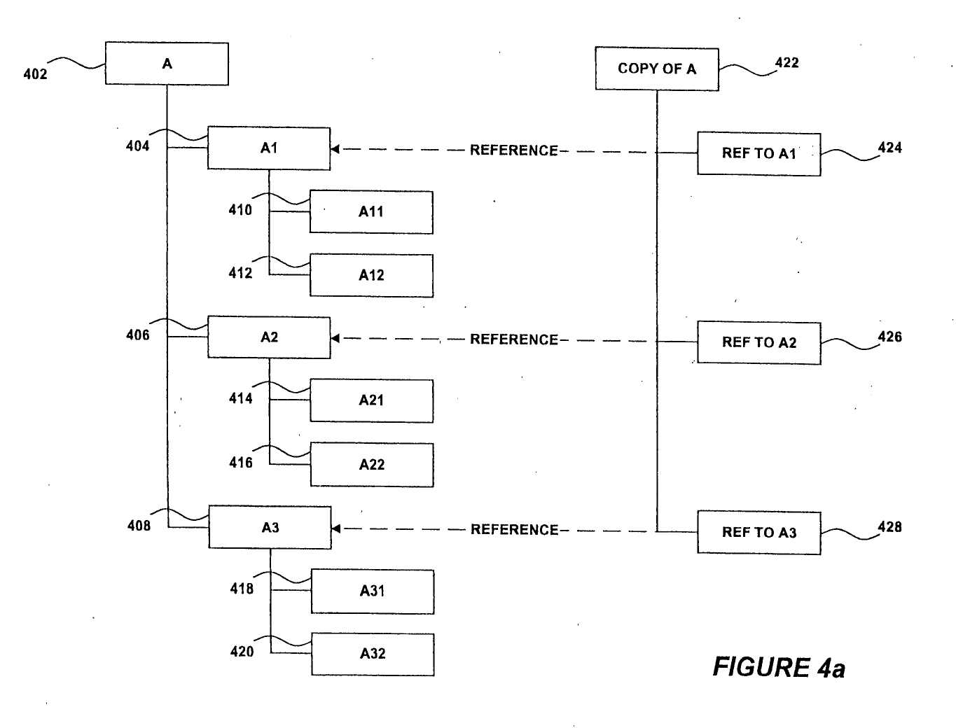

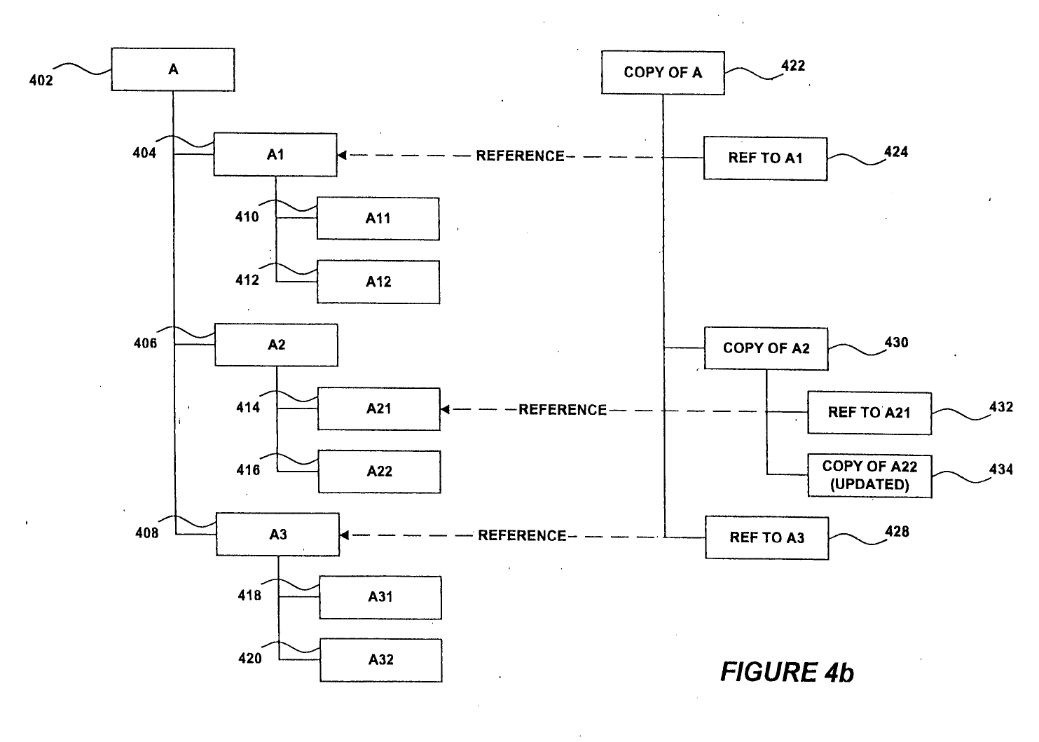

A method for updating a data item in a lazy copy of a data message in accordance with a preferred embodiment of the present invention will now be described with reference to FIGS. 3 and 4. FIG. 3 is a flow chart illustrating an exemplary method to update a nested data item addressed in a lazy copy of a data message in accordance with a preferred embodiment of the present invention. The method of FIG. 3 is applied to a lazy copy of a data message where the data message includes nested data items. A data item is said to be nested when it is contained within a different data item. Thus a data message including nested data items is structured as a tree data structure, with each data item constituting a single node in the tree. Accordingly, and as well known in the art, each node in the tree structure is said to have a parent node with the exception of a root node that is at the base of the tree structure. Also, as is well known in the art, each parent node includes a reference to its child nodes. Alternatively, each parent node can include its child nodes. In a data message, the data message itself can be considered to be a root node for a tree of data items. The steps of FIG. 3 are described in detail below with reference to a data message of FIGS. 4a and 4b that will be outlined first.

FIG. 4a is a block diagram of a lazy copy of a data message in accordance with a preferred embodiment of the present invention. A data message “A” 402 comprises three data items, “A1” 404, “A2” 406 and “A3” 408. The data message “A” 402 is a data message generated by a producer. The data message “A” 402 is considered to be the parent of data items “A1” 404, “A2” 406 and “A3” 408. Data item “A1” 404 includes nested data items “A11” 410 and “A12” 412. Also, data item “A2” 406 includes nested data items “A21” 414 and “A22” 416. Similarly, data item “A3” 408 includes nested data items “A31” 418 and “A32” 420. FIG. 4a further includes a lazy copy of data message “A” 402 as is generated by a consumer in a data messaging system. The lazy copy is represented as “COPY OF A” 422 and is a place-holder representing a copy of data message “A” 402. The “COPY OF A” 422 includes a data item for each of the data items of data message “A” 402 that have “A” 402 as a parent. Thus, “COPY OF A” 422 includes: “REFERENCE TO A1” 424 that is a reference to data item “A1” 404; “REFERENCE TO A2” 426 that is a reference to data item “A2” 406; and “REFERENCE TO A3” 428 that is a reference to data item “A3” 428. Thus, a consumer can access all of the data items of data message “A” 402 via “COPY OF A” 422 using the reference data items in “COPY OF A” 422. In this way, “COPY OF A” 422 is a lazy copy of data message “A” 402.

By way of example, the method of FIG. 3 will now be described for an update made to “COPY OF A” 422 by a consumer in the messaging system. In the example, the consumer addresses data item “A22” 416 via the “REFERENCE TO A2” 426 data item of “COPY OF A” 422. In one embodiment, the “REFERENCE TO A2” 426 is implemented as a memory pointer to the “A2” 406 data item in the data message “A” 402. Thus the consumer is able to access the data item “A22” 416 in the lazy copy “COPY OF A” 422 because “REFERENCE TO A2” 426 is a memory pointer to “A2” 406, and “A2” 406 includes “A22” 416. The consumer is said to address the data item “A22” 416 at the “COPY OF A” 422. Subsequently, the consumer makes an update to a value of the data item “A22” 416 addressed at the “COPY OF A” 422. The steps of the method of FIG. 3 are used to adapt “COPY OF A” 422 in order that this update can be made without affecting the data message “A” 402.

Starting at step 302, an actual copy of data item “A22” 416 is first created. Then at step 304 a loop is commenced through each parent of the data item to be updated. The data item to be updated is “A22” 416 that has a single parent of “A2” 406. Thus only a single iteration of the loop is required. More iterations will be required if the updated data item is more deeply nested in a tree structure of nested data items. Subsequently, at step 306, an actual copy of the parent data item is created as a parent of the actual copy of the updated data item. Thus, following step 306, copies are created as outlined below, with a copy of “A22” (the updated data item) and a copy of the parent of “A22”, which is “A2” (indentation indicates parenthood):
COPY OF A2
+→COPY OF A22

Then at step 308, a lazy copy is generated for all children of “A2” 406 other than the updated data item “A22” 416. Thus, a lazy copy placeholder data item is generated referencing all other children of “A2” 406. The data item “A2” 406 has one child other than “A22” 416, which is “A21” 414. Thus, a lazy copy placeholder is created referencing data item “A21” 414. Following step 308, copies have been created as outlined below, with a reference to “A21” inserted as a lazy copy of “A21” 414:
COPY OF A2
+→REFERENCE TO A21
+→COPY OF A22

Subsequently, at step 310 the loop tests if there are more parent data items of the updated data item. The updated data item “A22” 416 has only one parent and so the method proceeds to step 312. Finally, at step 312, the copies created using the method are inserted into “COPY OF A” 422. Thus, the “REFERENCE TO A2” 426 data item is replaced with the “COPY OF A2” data item created by method steps 302 to 308 as structured below:
COPY OF A2
+→REFERENCE TO A21
+→COPY OF A22

FIG. 4b is a block diagram of a lazy copy of the data message of FIG. 4a in which the “A22” 416 data item is updated in accordance with a preferred embodiment of the present invention. Many of the elements of FIG. 4b are identical to those described with respect to FIG. 4a and these will not be further described here in the description of FIG. 4b. FIG. 4b further includes a “COPY OF A2” 430 data item that is an actual copy of data item “A2” 406. The “COPY OF A2” 430 data item replaces the “REFERENCE TO A2” 426 data item of FIG. 4a. FIG. 4b also includes a “REFERENCE TO A21” 432 data item that is a placeholder with a reference to the “A21” 414 data item. Thus, the “REFERENCE TO A21” 432 data item is a lazy copy of the “A21” 414 data item. Furthermore, FIG. 4b includes “COPY OF A22” 434 that is an actual copy of “A22” 416. The “COPY OF A22” 434 has a value that has be updated.

Thus, the “COPY OF A” 422 of FIG. 4b includes an actual copy of only those data items required for the value of “A22” addressed at the “COPY OF A” 422 to be updated without changing a value of “A22” 416 in data message “A” 402. Other data items within “COPY OF A” 422 continue to be addressed as references as opposed to actual copies. For example “REFERENCE TO A21” 432 is a lazy copy of “A21” 414 as an actual copy of “A21” 414 is not required in “COPY OF A” 422. In this way a message consumer can make updates to “COPY OF A” 422 without the updates being visible to other consumers in the messaging system, and without generating redundant copies of unnecessary message data.

1. A method for generating a copy of a first message in a messaging system, wherein the first message includes a nested data item comprising data items, the method comprising the steps of:
creating a second message as a deferred copy of the first message;
in response to a determination that one of said data items addressed at the second message location is to be updated, creating an actual copy of the updated data item in the second message.

2. The method of claim 1 wherein the creating of an actual copy of the updated data item step further comprises creating an actual copy of a parent data item of the updated data item.

3. The method of claim 2 wherein the creating of an actual copy of the updated data item step further comprises creating a deferred copy of a child data item of the parent data item.

4. The method of claim 1 wherein the second message includes references to the nested data item.

5. The method of claim 4 wherein the references to the nested data item are memory pointers.

6. An apparatus for generating a copy of a first message in a messaging system, wherein the first message includes a nested data item comprising data items, the apparatus comprising:
means for creating a second message as a deferred copy of the first message;
means for, responsive to a determination that one of said data items addressed at the second message location is to be updated, creating an actual copy of the data item in the second message.

7. The apparatus of claim 6 wherein the means for creating an actual copy of the updated data item step further comprises means for creating an actual copy of a parent data item of the updated data item.

8. The apparatus of claim 7 wherein the means for creating an actual copy of the updated data item step further comprises means for creating a deferred copy of a child data item of the parent data item.

9. The apparatus of claim 6 wherein the second message includes references to the nested data item.

10. The apparatus of claim 9 wherein the references to the nested data item are memory pointers.

11. A computer program product comprising computer program code stored on a computer readable storage medium that, when executed on a data processing system, instructs the data processing system to carry out a method for generating a copy of a first message in a messaging system, wherein the first message includes a nested data item comprising data items, the method comprising the steps of:
creating a second message as a deferred copy of the first message;
in response to a determination that one of said data items addressed at the second message location is to be updated, creating an actual copy of the updated data item in the second message.
